(19) United States
(12) Patent Application Publication
(10) Pub. No.: US 2011/0196068 A1
(43) Pub. Date: Aug. 11, 2011

(54) RESIN COMPOSITION FOR OPTICAL LENS AND OPTICAL PACKAGING

(75) Inventors: DEIN-RUN FUNG, TAIPEI (TW); TE-CHAO LIAO, TAIPEI (TW); CHENG-YU YANG, TAIPEI (TW)

(73) Assignee: NAN YA PLASTICS CORPORATION, TAIPEI (TW)

(21) Appl. No.: 12/939,452

(22) Filed: Nov. 4, 2010

(30) Foreign Application Priority Data
Feb. 9, 2010 (TW) 99103908

(51) Int. Cl. C08L 63/00; C08K 3/34; C08K 3/22; B82Y 20/00

(52) U.S. Cl. 523/435; 525/407; 525/403; 524/500; 524/493; 524/408; 524/413; 524/430; 524/437; 524/436; 524/425; 524/497; 977/773; 977/810; 977/932

(57) ABSTRACT

A resin composition for optical lenses and optical packaging includes (1) 1 to 99.99 wt % mixture of epoxy, siloxane and epoxy-siloxane copolymers, (2) 0.01 to 5 wt % catalyst and (3) 0 to 40 wt % curing agent. The mixture of epoxy, siloxane and epoxy-siloxane copolymers includes (1) 1 to 85 wt % epoxy and siloxane oligomers, based on total weight of the mixture; (2) 1 to 90 wt % siloxane containing at least one alkoxy group, based on total weight of the mixture; (3) 1 to 80 wt % a epoxy resin having a benzene ring with at least one epoxy group or a hydrogenated benzene ring, or aliphatic epoxy resin, based on total weight of the mixture; (4) 1 to 70 wt % epoxy resin containing at least one hydroxyl group and at least an epoxy group, based on total weight of the mixture.

### CROSS-REFERENCE TO RELATED APPLICATION

This application claims priority under 35 U.S.C. §119 to Taiwan Patent Application No. 099103908, filed on 9 Feb. 2010, in the Taiwan Intellectual Property Office, the entire contents of which are hereby incorporated by reference.

The present invention relates to a resin composition of the mixture of epoxy, siloxane and epoxy-siloxane copolymers, and more particularly to a resin composition which has improved properties an epoxy resin and a siloxane resin originally have, such as heat resistance, yellowing resistance, light transmission, UV resistance, moisture resistance, dust proof, strong adhesion and crack proof, and therefore is applicable to optical lenses and optical packaging and coating, especially for LEDs.

### BACKGROUND OF THE INVENTION

1. Field of the Invention

The present invention relates to a resin composition of the mixture of epoxy, siloxane and epoxy-siloxane copolymers, and more particularly to a resin composition which has improved properties an epoxy resin and a siloxane resin originally have, such as heat resistance, yellowing resistance, light transmission, UV resistance, moisture resistance, dust proof, strong adhesion and crack proof, and therefore is applicable to optical lenses and optical packaging and coating, especially for LEDs.

2. Description of Related Art

A packaging of a conventional tight emission diode is obtained by encapsulating an epoxy resin in bulb form on a lead frame to enclose gold wires, crystalline solid plastic, dies, and electrodes. The bulb-form packaging has been substituted by a surface-mounted packaging.

The packaging resin is mainly epoxy resin which is based on bisphenol-A epoxy resin or cyclic aliphatic epoxy resin and anhydride, such as those described in U.S. Pat. No. 4,178,274. The shortcomings of those compositions are lack of thermal stability for curing accelerator such as tertiary amine, imidazoles or boron trifluoride complexes, and inadequate UV exposure resistance for bisphenol-A epoxy resin, especially in blue LED packaging.

In order to overcome the above shortcomings, organic compounds contain at least two double bonds and polysiloxane contains at least two SiH are subject to cross-linking reaction in the presence of catalyst and then curing. The obtained resin has improved UV exposure resistance but its adhesive surface after curing will sustain dusts which deteriorate the light transmission.

Some polysiloxane resins with high hardness have been proposed in U.S. Pat. No. 6,614,172. The reference improve the problem of dust adhesion, but still have the problem of poor adhesion. For example, in ceramic or plastic box-type LED with silicone resin package, the high-hardness silicone resin is easy to release in the thermal shock test at −40° C. to 120° C.

U.S. Pat. No. 4,082,719 discloses an epoxy and polysiloxane composition for injection molding. However, there are still problems of adhesion and yellowing resistance.

Another problem arising in the LED light crystals such as SiC, GaAs, GaP, GAsP, InGaN and GaN, etc. all of which have high refractive index. Siloxane with low refractive index will affect the efficiency of light emission and thus reduce the performance.

Many resin composition have solved adhesion problems, but have difficulty in mold release and mold change to separate from the metal mold when used in metal injection molding. U.S. Pat. No. 6,632,892 disclose some epoxy resins and silicone to resolve some weathering properties of epoxy resin and further enhance the adhesion of polysiloxane resin. However, no disclosures that the copolymerization of methoxy siloxane, hydroxyl-containing hydrogenated or non-hydrogenated epoxy resin, and hydrogenated aliphatic epoxy resin in the presence of catalyst to generate oligomers have been found yet.

Therefore, there is a need of a novel invention that overcomes the above disadvantages.

### SUMMARY OF THE INVENTION

It is one object of the present invention to provide a resin composition with superior heat resistance, improved UV resistance, improved adhesion of the siloxane resin, and improved moisture resistance.

In order to achieve the above and other objectives, a resin composition of the invention includes (1) 1 to 99.99 wt, mixture of epoxy and siloxane copolymer; (2) 0.01 to 5 wt % catalyst; (3) 0 to 40 wt % curing agent; (4) 0-5 wt % curing accelerator; (5) 0 to 10 wt % initiator;

(6) 0 to 30 wt % inorganic powders; and
(7) 0 to 10 wt % processing additives. The purpose of adding the curing accelerator is to accelerate the cross linking reaction between the resin and the curing agent. The amount of the curing accelerator affects the reaction rate. The inorganic powders contribute to increase the index of refraction and mechanic properties of the resin composition according to the invention, and also maintain LED at high brightness. The processing additives includes one or more selected the group consisting of adhesion promoters, UV absorbers, antioxidants, fillers, coupling agents, strengthening filler, plasticizer, dispersing agent, heat and light stabilizers, flame retardants, pigments or dyes. The processing additives are used to improve the processing properties, mechanical and electrical properties, thermal properties and light stability of the resin composition.

The mixture of epoxy and siloxane copolymer includes (1) 1 to 85 wt % epoxy and siloxane oligomers, based on total weight of the mixture, preferably 10 to 60%; (2) 1 to 90 wt % siloxane containing at least one alkoxy group, based on total weight of the mixture; (3) 1 to 80 wt % epoxy resin having a benzene ring with at least one epoxy group or a hydrogenated benzene ring, or aliphatic epoxy resin, based on total weight of the mixture; and (4) 1 to 70 wt % epoxy resin containing at least one hydroxyl group and at least an epoxy group, based on total weight of the mixture. The resin composition has superior heat resistance, improved UV resistance, improved adhesion of the siloxane resin, and improved moisture resistance.

In order to further understand the techniques, means and effects the present invention takes for achieving the prescribed objectives, the following detailed descriptions and appended drawings are hereby referred, such that through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic view of a LED package to which a resin composition according to the invention is applied in a first form.

FIG. 2 is a schematic view of a LED package to which a resin composition according to the invention is applied in a second form.

FIG. 3 is a GPC analysis graph obtained after the reaction of the epoxy resin and siloxane, where

Under 22 minutes: epoxy and siloxane oligomers, methoxy siloxane and its oligomers; concentration of 48.9%;

22-24 minutes: hydroxyl-containing hydrogenated bisphenol-A epoxy resin (EEW=425 g/eq, Nan Ya Plastics Corporation, Name: NPEH-901, n=2); concentration of 21.2%;

24-28 minutes: hydrogenated bisphenol-A epoxy resin (EEW=209 g/eq, Nan Ya Plastics Corporation, Name: NPEH-128, n=0); concentration of 29.9%.

### DETAILED DESCRIPTION OF THE PREFERRED EMBODIMENTS

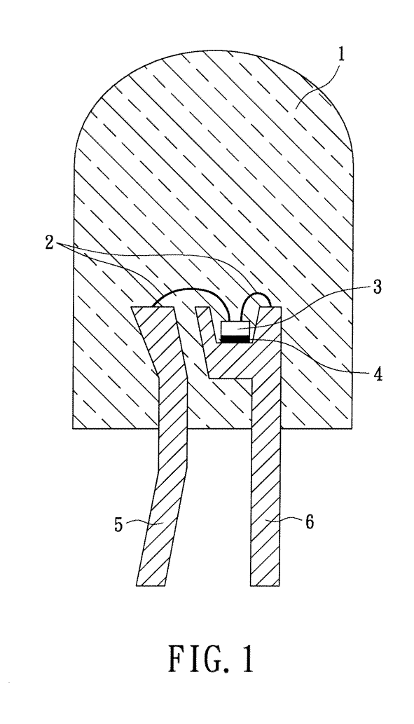

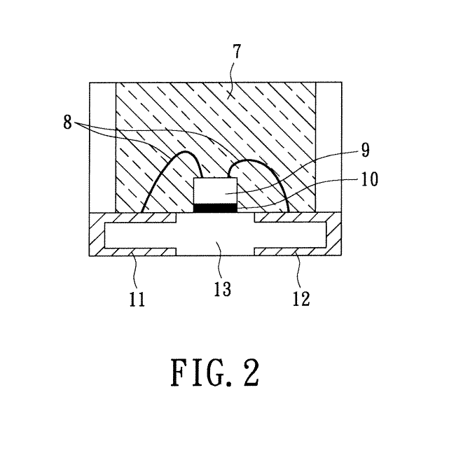

The resin composition of invention has improved adhesion and moisture resistance which epoxy resin has originally, and improved heat resistance. UV resistance which siloxane resin has originally. Furthermore the resin composition of the invention has superior light transmission to the commercial siloxane resin. Therefore, it can be applied to optical lenses and optical packaging, especially LED packaging as shown in FIG. 1 and FIG. 2.

The resin composition of the invention includes (1) the mixture of epoxy, siloxane and epoxy-siloxane copolymers; (2) catalyst; (3) curing agent; (4) 0-5 wt % curing accelerator; (5) initiator; (6) inorganic powders; and (7) processing additives. The mixture of epoxy, siloxane and epoxy-siloxane copolymers includes epoxy and siloxane oligomers, siloxane containing at least one alkoxy group, an epoxy resin having a benzene ring with at least one epoxy group or a hydrogenated benzene ring, or aliphatic epoxy resin, epoxy resin containing at least one hydroxyl group and at least an epoxy group. The epoxy and siloxane oligomers are obtained by reaction of the siloxane containing at least one alkoxy group, the epoxy resin having a benzene ring with at least one epoxy group or a hydrogenated benzene ring, or aliphatic epoxy resin, with the epoxy resin containing at least one hydroxyl group and at least an epoxy group.

The mixture of epoxy, siloxane and epoxy-siloxane copolymers is obtained by catalytic reaction of the siloxane containing at least one alkoxy group, the epoxy containing hydroxyl group and epoxy resin, and has molecular weight in the range of 500 to 1,000,000, preferably 1,000 to 100,000. The molecular weight can be various for different application.

The siloxane containing at least one alkoxy group in the resin composition of the invention has the following formula (1):

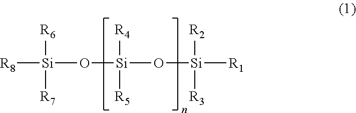

wherein n is an integer in the range of 0<n<100; R₁, R₂, R₃=phenyl group, or alkyl group of 1-6 carbon atoms or alkoxy group of 1 to 4 carbon atoms or alkyl group containing epoxy group or acrylate group, where R₁, R₂, R₃ are the same or different; R₄ is alkoxy group of 1 to 4 carbon atoms, or alkyl group containing epoxy group or acrylate group; R₅ is alkyl group of 1-6 carbon atoms, or phenyl group; R₆, R₇, R₈=one of phenyl up, alkyl group of 1-6 carbon atoms, alkoxy group of 1 to 4 carbon atoms, alkyl group containing epoxy group or acrylate group, where R₆, R₇, R₈ are the same or different;

when n>1. R₅ has, in molar ratio range, 0 to 100% alkyl group and 0 to 100% phenyl group, in a mixed formulation or single formulation of either alkyl group or phenyl group; when R₅ has both of alkyl up and phenyl group, it has the following formula (2):

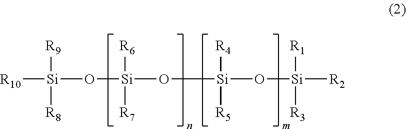

where:
n and m are integers in the range of 0<n<50 and 0<m<50; R₁, R₂, R₃=one of phenyl group, alkyl group of 1-6 carbon atoms, 1 to 4 carbon alkoxy, or alkyl group containing epoxy group or acrylate group, where R₁, R₂, R₃ are the same or different; R₄ is alkoxy group of 1 to 4 carbon atoms, or alkyl group containing epoxy group or acrylate group; R₅ is alkyl group of 1-6 carbon atoms; R₆ is any one of alkoxy group of 1 to 4 carbon atoms, alkyl group containing epoxy group or acrylate group, or branched methyl siloxane, phenyl siloxane or epoxy siloxane; R₇ is phenyl group; R₈, R₉, R₁₀=one of phenyl group, alkyl group of 1-6 carbon atoms, alkoxy group of 1 to 4 carbon atoms, or alkyl group containing epoxy group or acrylate group, where R₈, R₉, R₁₀ are the same or different.

The epoxy resin having a benzene ring with at least one epoxy up or a hydrogenated benzene ring, or aliphatic epoxy resin in the resin composition of the invention is an epoxy resin containing at least a single functional group with 100-2000 equivalents of epoxy, and is one or more selected from the group consisting of bisphenol-A epoxy resin, bisphenol-F epoxy resin, hydrogenated bisphenol-A epoxy resin, hydrogenated bisphenol-F epoxy resin, butadiene epoxy resin, o-cresol Novolac formaldehyde epoxy resin, cresol Novolac formaldehyde epoxy resin, cresol Novolac dibenzez formaldehyde epoxy resin, cresol Novolac xylene formaldehyde epoxy resin, cresol Novolac diphenyl formaldehyde epoxy resin, cresol Novolac dicyclopentadiene formaldehyde epoxy resin, cresol Novolac benzaldehyde epoxy resin, cresol Novolac propylidene diphenol formaldehyde epoxy resin, and cresol Novolac resorcinol epoxy resin.

The epoxy resin containing, at least one hydroxyl group and at least an epoxy group in the resin composition of the invention has following formula (3):

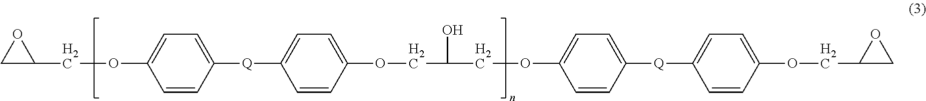

where
n is an integer in the range of 0<n<6; Q is

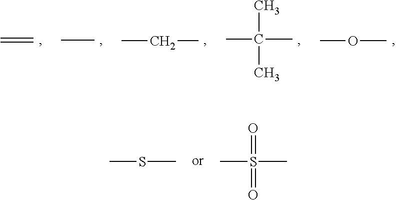

with the epoxy equivalents of 100-2000, and selected from the group consisting of bisphenol-A epoxy resin, bisphenol-F epoxy resin, hydrogenated bisphenol-A epoxy resin, hydrogenated bisphenol-F epoxy resin, or hydroxyl group-containing epoxy which is replaced with a hydroxyl group-containing fluorine resin.

The curing agent in the resin composition of the invention is an anhydride curing agent, and is selected from the group consisting of styrene-maleic anhydride, phthalic anhydride, tetrahydro phthalic anhydride, hexahydrophthalic anhydride, methyl tetrahydro phthalic anhydride, methyl hexahydrophthalic anhydride, methyl nadic anhydride, dodecenyl succinic anhydride, green bacteria anhydride, pyromellitic anhydride, benzophenonetetracarboxylic dianhydride, ethylene glycol di[trimellitic anhydride], methyl cyclohexenyl tetracarboxylic dianhydride, trimellitic anhydride or poly azelaic anhydride.

The curing agent accelerator in the resin composition of the invention is selected from the group consisting of tertiary amine and the salts thereof, quaternary amine salt compound, 2,4,6-tris(dimethyl amino methyl)phenol, benzyl dimethylamine, imidazole, tripentyl phenolate ammonium, mono- or poly-phenolic compounds, complex of boron trifluoride and organic compounds, or triphenyl phosphate or phosphite. Among those curing accelerator above, quaternary amine salt compound is prefer used.

The initiator in the resin composition of the invention is one or more thermally curing cationic initiator, and can be selected from the group consisting of diazonium salt, sulfonium salt and iodonium salt mixture. For example, the initiator can be one or more selected from the group consisting of CI-2855, CI-2624 (NIPPON SODA company), CAT EX-1 (DAICEL CHEMICAL INDUSTRIES company), ADEKA OPTOMER CP-66, ADEKA OPTOMER CP-67 (ASAHI DENKA company), San-Aid SI-60L, San-Aid SI-80L, San-Aid SI-100L (SANSIIIN CHEMICAL INDUSTRY company), NB-101, and NB-201 (Midori Kagaku company).

The catalyst in the resin composition of the invention is one or more selected from the group consisting of titanium, tin, aluminum, zinc, boron organic metals and phosphate catalyst.

The role of the inorganic powders in the resin composition of the invention is to increase the index of refraction and mechanic properties of the resin composition, and also maintain the LED at high brightness. The inorganic powders can further couple with a coupling agent containing an epoxy group, resulting in improved dispersion and molecule stability. The inorganic powders in the resin composition of the invention are one or more selected from the group consisting of spherical or irregular silicon dioxide (SiO₂), niobium oxide (Nb₂O₅), tantalum oxide (Ta₂O₅), zirconia (Zr₂O₃), alumina (Al₂O₃), titanium dioxide (TiO₂), aluminum hydroxide (Al(OH)₃), magnesium hydroxide (Mg(OH)₂), calcium carbonate (CaCO₃) or smoked silica, with the average size of 0.1 to 20 microns, preferably 1 to 100 nanometers.

A coupling agent can be added to the resin composition of the invention to modify the interface affinity between the inorganic powders and the resin. The coupling agent can be directly added to the resin composition, or combined with the resin composition after pre-treated. The coupling agent is one or more selected from the group consisting of dimethoxy silane (DMS), trimethoxy silane (TMS), and titanium aluminum ester.

The processing additives in the resin composition of the invention includes one or more selected the group consisting of adhesion promoters UV absorbers, antioxidants, fillers, coupling agents, strengthening filler, plasticizer, dispersing agent, heat and light stabilizers, flame retardants, pigments or dyes.

The UV absorbers used in the invention is one or more selected from the group consisting of hydroxyl phenyl benzotriazole UV absorber, and hydroxyl dibenzophenone UV absorber. The filler is one or more selected from the group consisting of calcium carbonate, alumina, and molybdenum disulfide. The coupling agent is one or more selected from the group consisting of dimethoxy silane (DMS), trimethoxy silane (TMS) and titanium aluminum ester. The plasticizer is one or more selected from the group consisting of dimethyl phthalate, trioctyl trimellitate, dinonyl phosphate.

The dispersing agent is one or more selected from the group consisting styrene-maleic anhydride copolymer and long-chain fatty alcohol. The anti-oxidant is one or more selected from the group consisting of dilauryl thiodipropionate, di-tertiary butyl-hydroxyl toluene. The heat and light stabilizer is benzophenone. The flame retardant is one or more selected from the group consisting of tricresyl phosphate, triphenyl phosphate, and cresyl phenyl phosphate.

The resin composition of the invention is principally in the form of two-liquid phases, even though one liquid form is acceptable, as long as it has long-term stability in storage. For the curing condition, the temperature can be up to 180° C., which can be adjusted at single or multiple stages according to the requirements for products. The resin composition of the invention after being hardened offers the following advantages:

1. Superior resistance to heat and yellowing

2. Superior resistance to ultraviolet light

3. Improved light transmission

4. Improved durability for epoxy resin

5. Better impact resistance than the prior art using siloxane

6. Better moisture resistance than the prior art using siloxane.

### EXAMPLES

The following examples and comparative examples are used to illustrate the invention, without limiting the scope of the invention.

[Test Method]

1. Packaging of Light-Emitting Diodes

The mixture of epoxy, siloxane and epoxy-siloxane copolymers is obtained by using anhydride as the curing agent. The curing agent of methyl hexahydrophthalic anhydride (MHHPA) is used. The amount of anhydride is determined according to the equivalent ratio of anhydride group to epoxy group=0˜1.5, preferably 0.01-0.75. The ratio of epoxy resin to siloxane is adjustable. It can be one-liquid or two-liquid form. Quaternary amine salt of 0.015 weight parts, preferably 0.01-2 weight parts can be added as the curing accelerator. The cationic initiator of 0-10 weight parts, preferably 0-5 weight parts is added. A solvent of 0-10 weight parts is used to adjust the viscosity. The solvent is preferably toluene and methyl ethyl ketone.

After one curing agent (two-liquid form) or no curing agent (one-liquid form), curing accelerator (two-liquid form) or no curing accelerator (one-liquid form), one cationic initiator or no cationic initiator, and inorganic powders and the processing additives are added to the resin mixture, the mixture is kept at 80° C. for 2 hours and at 15° C. for 4 hours, and then used for packaging, as shown in FIG. 1.

2. Brightness Test

An InGaN die of 455 nm wavelength is subject to wire bonding, coated with the resin composition of the invention and then hardened to form a light-emitting, diode bulb. The obtained light emitting diode is subject to brightness test using a 50 mA current for 168 hours. The level of brightness before and after the test can be regarded as performance test for packaging resin.

3. Yellowing Test at 150° C. for 24 Hours

A specimen made from the hardened resin mixture of the invention is subject to a thermal cycle at 150° C. for 24 hours in thermal cycling oven. Then the value of yellowness change (ΔYI) before and after testing is measured.

4. Weathering Test by Exposing to UV for 168 Hours

A specimen made from the hardened resin mixture of the invention is subject to the exposure to UV light for 168 hours in a Q-PANEL model QUV/SE exposure weathering test machine. The changes of the yellow value (ΔYI) before and after test are measured.

5. Glass Transition Point Tg Testing:

A specimen made from the hardened resin mixture of the invention is subject to a glass transition point Tg test in a Differential Scanning calorimeter of model DSC-2910 available from Chupin TA Instruments Inc.

### Example 1 (E1)

33 weight parts of solid-type hydrogenated bisphenol-A epoxy resin (EEW=209 g/eq, Nan Ya Plastics Corporation, Trade Name: NPEH-128, n=0) 33 weight parts of hydroxyl-containing hydrogenated bisphenol-A epoxy Resin (EEW=425 g/eq. Nan Ya Plastics Corporation, Name: NPEH-901, n=2), 33 weight parts of methyl methoxy siloxane (methoxy of 28 wt %) and 1 weight part of acyl acetone aluminum catalyst are dissolved in 30 weight parts of toluene. In a dry nitrogen system, heat for 1 hour at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Example 2

40 weight parts of solid-type hydrogenated bisphenol-A epoxy resin (EEW=209 g/eq, Nan Ya Plastics Corporation, Trade Name: NPEH-128, n=0) 40 weight parts of hydroxyl-containing hydrogenated bisphenol-A epoxy Resin (EEW=425 g/eq, Nan Ya Plastics Corporation, Name: NPEH-901, n=2), 20 weight parts of methyl methoxy siloxane (methoxy of 28 wt %) and 1 weight part of aluminum catalyst are dissolved in 30 weight parts of toluene. In a dry nitrogen system, heat for 40 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Example 3

60 weight parts of solid-type hydrogenated bisphenol-A epoxy resin (EEW=209 g/eq, Nan Ya Plastics Corporation, Trade Name: NPEH-128, n=0), 20 weight parts of hydroxyl-containing hydrogenated bisphenol-A epoxy Resin (EEW=425 g/eq, Nan Ya Plastics Corporation, Name: NPEH-901, n=2), 20 weight parts of methyl methoxy siloxane (methoxy of 28 wt %) and 1 weight part of acyl acetone aluminum catalyst are dissolved in 10 weight parts of toluene. In a dry nitrogen system, heat for 45 min at 90° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Example 4

40 weight parts of solid-type hydrogenated bisphenol-A epoxy resin (EEW=209 g/eq, Nan Ya Plastics Corporation, Trade Name: NPEH-128, n=0), 10 weight parts of aliphatic epoxy resin, 20 weight parts of hydroxyl-containing hydrogenated bisphenol-A epoxy Resin (EEW=42 Nan Ya Plastics Corporation, Name: NPEH-901, n=2), 40 weight parts of methyl methoxy siloxane (methoxy of 28 wt %) and 1 weight part of acyl acetone aluminum catalyst are dissolved in 18 weight parts of toluene. In a dry nitrogen system, heat for 25 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Example 5

10 weight parts of solid-type hydrogenated bisphenol-A epoxy resin (EEW=209 g/eq, Nan Ya Plastics Corporation, Trade Name: NPEH-128, n=0), 50 weight parts of hydroxyl-containing hydrogenated bisphenol-A epoxy Resin (EEW=425 g/eq. Nan Ya Plastics Corporation, Name: NPEH-901, n=2), 40 weight parts of methyl methoxy siloxane (methoxy of 28 wt %) and 1 weight part of acyl acetone aluminum catalyst are dissolved in 30 weight parts of toluene. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Example 6

30 weight parts of solid-type hydrogenated bisphenol-A epoxy resin (EEW=209 g/eq, Nan Ya Plastics Corporation, Trade Name: NPEH-128, n=0) 30 weight parts of hydroxyl-containing hydrogenated bisphenol-A epoxy Resin (EEW=425 g/eq, Nan Ya Plastics Corporation, Name: NPEH-901, n=2), 40 weight parts of methyl methoxy siloxane (methoxy of 28 wt %) and 1 weight part of acyl acetone aluminum catalyst are dissolved in 30 weight parts of toluene. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Example 7

30 weight parts of solid-type hydrogenated bisphenol-A epoxy resin (EEW=209 g/eq, Nan Ya Plastics Corporation, Trade Name: NPEH-128, n=0), 30 weight parts of hydroxyl-containing hydrogenated bisphenol-A epoxy Resin (EEW=425 g/eq. Nan Ya Plastics Corporation, Name: NPEH-901, n=2), 40 weight parts of methyl methoxy siloxane (methoxy of 28 wt %) and 1 weight part of acyl acetone aluminum catalyst are dissolved in 30 weight parts of toluene. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1, wherein 1 weight part of UV absorber (Ciba, TINUVIN B75) is further added in testing.

### Example 8

30 weight parts of solid-type hydrogenated bisphenol-A epoxy resin (EEW=209 g/eq, Nan Ya Plastics Corporation, Trade Name: NPEH-128, n=0), 30 weight parts of hydroxyl-containing hydrogenated bisphenol-A epoxy Resin (EEW=425 g/eq. Nan Ya Plastics Corporation, Name: NPEH-901, n=2), 40 weight parts of methyl methoxy siloxane (methoxy of 28 wt %) and 1 weight part of acyl acetone aluminum catalyst are dissolved in 30 weight parts of toluene. In a dry nitrogen system, heat for 30 min at 80° C. under reflow. A mixed resin of epoxy-siloxane copolymer, methoxy siloxane and epoxy resin is obtained.

As formulated in Table 1, 5 weight part of nano silicon dioxide (Evonik, Name: AEROSIL 200) is further added in testing, and silicon dioxide is pretreated by a coupling agent dimethoxy silane (DMS) and then distributed into the mixed resin obtained above. The results are detailed in Table 1 below.

### Example 9

30 weight parts of solid-type hydrogenated bisphenol-A epoxy resin (EEW=209 g/eq, Nan Ya Plastics Corporation, Trade Name: NPEH-128, n=0), 30 weight parts of hydroxyl-containing hydrogenated bisphenol-A epoxy Resin (EEW=425 g/eq, Nan Ya Plastics Corporation. Name: NPEH-901, n=2), 40 weight parts of epoxy methoxy siloxane (methoxy of 9.6 wt %, EEW=323 g/eq) and 1 weight part of acyl acetone aluminum catalyst are mixed. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in

TABLE 1

| | | E 1 | E 2 | E 3 | E 4 | E 5 | E 6 | E 7 | E 8 | E 9 | E 10 | E 11 | E 12 | CE 1 | CE 2 | CE 3 |
|---|---|---|---|---|---|---|---|---|---|---|---|---|---|---|---|---|
| aliphatic epoxy resin | | — | — | — | 10 | — | — | — | — | — | — | — | — | — | — | — |
| hydrogenated | | 33 | 40 | 60 | 40 | 10 | 30 | 30 | 30 | 30 | 32 | 50 | 50 | — | 60 | 50 |
| bisphenol-A epoxy | | | | | | | | | | | | | | | | |
| resin | | | | | | | | | | | | | | | | |
| hydroxyl hydrogenated | | 33 | 40 | 20 | 20 | 50 | 30 | 30 | 30 | 30 | 24 | — | — | — | — | — |
| bisphenol-A epoxy | | | | | | | | | | | | | | | | |
| resin | | | | | | | | | | | | | | | | |
| Bisphenol-A epoxy | | — | — | — | — | — | — | — | — | — | — | — | — | 33 | — | — |
| resin | | | | | | | | | | | | | | | | |
| hydroxyl bisphenol-A | | — | — | — | — | — | — | — | — | — | — | — | — | 33 | 20 | — |
| epoxy resin | | | | | | | | | | | | | | | | |
| methyl methoxy | | 33 | 20 | 20 | 40 | 40 | 40 | 40 | 40 | — | — | — | — | — | — | — |
| siloxane | | | | | | | | | | | | | | | | |
| methyl phenyl | | — | — | — | — | — | — | — | — | — | — | — | — | 33 | 20 | 30 |
| methoxy siloxane | | | | | | | | | | | | | | | | |
| epoxy methoxy | | — | — | — | — | — | — | — | — | 40 | 44 | 40 | 40 | — | — | — |
| siloxane | | | | | | | | | | | | | | | | |
| methoxy acrylate | | — | — | — | — | — | — | — | — | — | — | — | 10 | — | — | — |
| siloxane | | | | | | | | | | | | | | | | |
| fluorine-containing | | — | — | — | — | — | — | — | — | — | — | 10 | — | — | — | — |
| resin | | | | | | | | | | | | | | | | |
| catalyst | acyl | 1 | 1 | 1 | 1 | 1 | 1 | 1 | 1 | 1 | 1 | 1 | 1 | 1 | 1 | 1 |
| | acetone | | | | | | | | | | | | | | | |
| Curing | MHHPA* | 5 | 7 | 7 | 5 | 5 | 5 | 5 | 5 | 5 | 5 | 5 | 5 | 5 | 6 | 4 |
| agent | | | | | | | | | | | | | | | | |
| Curing | Quaternary | 0.05 | 0.05 | 0.05 | 0.05 | 0.05 | 0.05 | 0.05 | 0.05 | 0.05 | 0.05 | 0.05 | 0.05 | 0.05 | 0.05 | 0.05 |
| accelerator | amine salt | | | | | | | | | | | | | | | |
| Initiator | sulfonium | 0.1 | 0.1 | 0.1 | 0.1 | 0.1 | 0.1 | 0.1 | 0.1 | — | — | — | 0.1 | 0.1 | 0.1 | 0.1 |
| | salt | | | | | | | | | | | | | | | |
| Inorganic | Silicon | — | — | — | — | — | — | — | 5 | — | — | — | — | — | — | — |
| powders | dioxide | | | | | | | | | | | | | | | |
| Processing | UV | — | — | — | — | — | — | 1 | — | — | — | — | — | — | — | — |
| Additives | absorber | | | | | | | | | | | | | | | |

| | | | | | | | | | | | | | | | |
|---|---|---|---|---|---|---|---|---|---|---|---|---|---|---|---|
| Hardness | 40 D | 37 D | 20 D | 41 D | 52 D | 67 D | 63 D | 72 D | 15 D | 52 D | 75 A | 80 A | 55 D | 36 D | 78 A |
| (shore A~D) | | | | | | | | | | | | | | | |
| Tg (° C.) | 78 | 67 | 63 | 84 | 45 | 72 | 70 | 78 | — | — | — | — | 108 | 81 | 23 |
| Heat resistance | 9.4 | 11.4 | 8.2 | 2.8 | 7.3 | 0.4 | 0.6 | 0.4 | 3.7 | 2.1 | 2.6 | 7.5 | 23.7 | 22.8 | 18.6 |
| 150° C. 24 hr(ΔYI) | | | | | | | | | | | | | | | |
| Exposure to UV, | 15.4 | 1.7 | 11.2 | 4.5 | 4.4 | 2.5 | 2.0 | 2.2 | 6.2 | 2.5 | 3.9 | 12.8 | 32.5 | 24.3 | 3.8 |
| 168 hrs | | | | | | | | | | | | | | | |
| (ΔYI) | | | | | | | | | | | | | | | |
| 50 mA, 168 hrs, | 81.4 | 85.7 | 92.4 | 89.6 | 97.3 | 106.3 | 102.8 | 108.2 | 87.1 | 101.2 | 96.1 | 82.0 | 39.5 | 60.9 | 70.2 |
| brightness | | | | | | | | | | | | | | | |
| maintenance(%) | | | | | | | | | | | | | | | |

NOTE:
1. Aluminum catalyst is under 1phr.
2. Reaction condition is 80-90° C. and 25-60 min.
3. The solvent is toluene.
4. The curing agent MHHPA* is methyl hexahydrophthalic anhydride

### Example 10

32 weight parts of solid-type hydrogenated bisphenol-A epoxy resin (EEW=209 g/eq, Nan, Ya Plastics Corporation, Trade Name: NPEH-128, n=0) 24 weight parts of hydroxyl-containing hydrogenated bisphenol-A epoxy Resin (EEW=425 g/eq, Nan Ya Plastics Corporation, Name: NPEH-901, n=2), 44 weight parts of epoxy methoxy siloxane (methoxy of 11.5 wt %, EEW=1076 g/eq) and 1 weight part of acyl acetone aluminum catalyst are mixed. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table I.

### Example 11

50 weight parts of solid-type hydrogenated bisphenol-A epoxy resin (EEW=209 g/eq, Nan Ya Plastics Corporation, Trade Name: NPEH-128, n=0), 10 weight parts of fluorine-containing resin (Daikin Chemical, GK-570), 40 weight parts of epoxy methoxy siloxane (methoxy of 11.5 wt EEW=1076 g/eq) and 1 weight part of acyl acetone aluminum catalyst are mixed. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the Formulation and the test conditions of the specimens are detailed in Table 1.

### Example 12

50 weight parts of solid-type hydrogenated bisphenol-A epoxy resin (EEW=209 g/eq. Nan Ya Plastics Corporation, Trade Name: NPEH-128, n=0), 10 weight parts of methoxy acrylate siloxane (double bond of 12.1 wt %), 40 weight parts of epoxy methoxy siloxane (methoxy of 11.5 wt %, EEW=1076 g/eq), 1 weight part of initiator (Double Bond Chemical, CHIVACURE 173) and 1 weight part of acyl acetone aluminum catalyst are mixed. In a dry nitrogen system, heat for 30 min at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Comparative Example 1

Reference is made as CE 1 shown in Table 1. 33 weight parts of solid-type bisphenol-A epoxy resin (EEW=185 g/eq, Nan Ya Plastics Corporation, Trade Name: NPEL-128, n=0), 33 weight parts of hydroxyl-containing bisphenol-A epoxy resin (EEW=425 g/eq, Nan Ya Plastics Corporation, Name: NPEL-901, n=2), 33 weight parts of methyl phenyl methoxy siloxane (methoxy of 19 wt %) and 1 weight part of acyl acetone aluminum catalyst are dissolved in 5 weight parts of toluene. In a dry nitrogen system, heat for 1 hour at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Comparative Example 2

Reference is made as CE 2 shown in Table 1. 60 weight parts of solid-type hydrogenated bisphenol-A epoxy resin (EEW=209 g/eq, Nan Ya Plastics Corporation, Trade Name: NPEH-128, n=0) 20 weight parts of hydroxyl-containing hydrogenated bisphenol-A epoxy Resin (EEW=413 g/eq, Nan Ya Plastics Corporation, Name: NPEL-901, n=2), 20 weight parts of methyl phenyl methoxy siloxane (methoxy of 19 wt %) and 1 weight part of acyl acetone aluminum catalyst are dissolved in 10 weight parts of toluene. In a dry nitrogen system, heat for 45 min at 90° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

### Comparative Example 3

Reference is made as CE 3 shown in Table 1. 50 weight parts of solid-type hydrogenated bisphenol-A epoxy resin (EEW=209 g/eq, Nan Ya Plastics Corporation, Trade Name: NPEH-128, n=0), 30 weight parts of methyl phenyl methoxy siloxane (methoxy of 19 wt %) and 1 weight part of acyl acetone aluminum catalyst are dissolved in 30 weight parts of toluene. In a dry nitrogen system, heat for 1 hour at 80° C. under reflow. A mixed resin of epoxy-siloxane copolymer, methoxy siloxane and epoxy resin is obtained.

The performance and physical properties of light-emitting diode and the formulation and the test conditions of the specimens are detailed in Table 1.

With comparison of Example 1 through Example 12 and Comparative Example 1 through Comparative Example 3, it is found the following conclusions:

1. In Example 1 and Example 2, the proportions of hydroxyl hydrogenated bisphenol-A epoxy resin and hydrogenated bisphenol-A epoxy resin increase. Even though the heat yellowing (ΔYI=11.4) of Example 2 is slightly worse than example 1 (ΔYI=9.4), its weathering resistance exposing to UV light ultraviolet rays (ΔYI=1) is far superior to Example 1 (ΔYI=15.4). The brightness maintenance 85.7% of example 2 is better than 81.4% of Example, 1.

2. In Comparative Example 1, hydroxyl-containing hydrogenated bisphenol-A epoxy resin and hydrogenated bisphenol-A epoxy resin of Example 1 are respectively replaced with hydrogenated bisphenol-A epoxy resin and bisphenol-A epoxy resin, and methyl methoxy siloxane of Example 1 is replaced with methyl phenyl methoxy siloxane replaced. Although Tg increases, the heat resistance and the yellowing resistance to ultraviolet are worse. Therefore, the brightness maintenance of Comparative Example 1 is only 39.5%.

3. In Comparative Example 2, in the same proportion, hydroxyl hydrogenated bisphenol-A epoxy resin of Example 3 is replaced with hydrogen to hydroxyl bisphenol-A epoxy resin. Although Tg increases the heat resistance and the yellowing resistance to ultraviolet are worse. Therefore, the brightness maintenance of Comparative Example 2 is only 60.9%.

4. From Example 5 and 6, in the same proportion of methoxy siloxane, different proportions of hydroxyl hydrogenated bisphenol-A epoxy resin and hydrogenated bisphenol-A epoxy resin are used, 1:1 of hydroxyl hydrogenated bisphenol-A epoxy resin and hydrogenated bisphenol-A epoxy resin are used in Example 6, which gains brightness maintenance of 106.3% better than 97.3% of Example 5.

5. In Comparative Example 3 in which no hydroxyl hydrogenated bisphenol-A epoxy resin is added and methoxyl siloxane is added in a similar ratio with Examples 4, 5, 6, the brightness maintenance is only 70.2% much lower than Examples 4, 5, 6. This may mainly due to deterioration of heat resistance and yellowing resistance.

6. The UV absorber is added in Example 7, and the brightness maintenance is 102.8% almost equal to Example 6. It illustrates addition of the UV absorber contributes to get the effect of the invention.

7. 5 weight parts of nano silicon dioxide is added in Example 8. The brightness maintenance is up to 108.2%, the highest among those Examples. It illustrates addition of the amount of 0.01-10 wt % of nano silicon dioxide in the resin composition has the best effect.

8. In Examples 9 and 10, addition of methoxy-containing epoxy siloxane resin help to increase the cross-linking density of epoxy resin. When the methoxy value decreases to 9.6% and 11.5%, the storage stability and viscosity increase.

9. In Example 11, the replacement of NPEH-901 with the fluorine-containing resin contributes to increase the LED's brightness maintenance up to 96.1% after curing.

10. In Example 12, the replacement of NPEH-901 with acryl methoxy siloxane contributes to increase the LED's brightness maintenance up to 82.0% after curing.

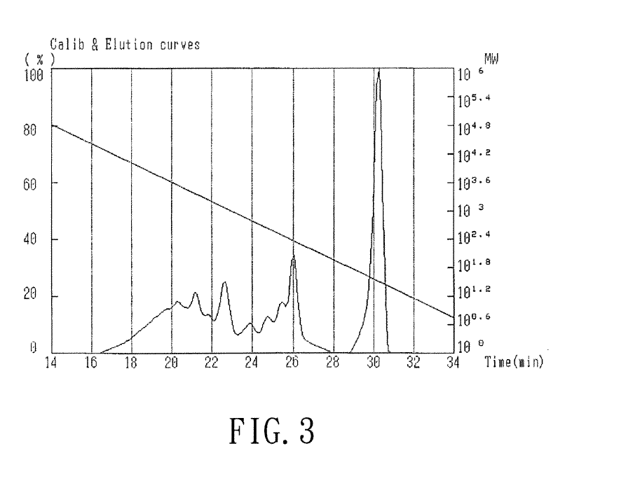

The mixture of epoxy and siloxane copolymers, obtained In Example 1 through Example 12, is subject to GPC analysis. The result is shown in FIG. 3, with 1 to 85 wt % epoxy and siloxane oligomers based on total weight of the mixture, 1 to 90 wt % siloxane containing at least one alkoxy group based on total weight of the mixture, 1 to 80 wt % epoxy resin having a benzene ring with at least one epoxy group or a hydrogenated benzene ring, or aliphatic epoxy resin, based on total weight of the mixture, and 1 to 70 wt % epoxy resin containing at least one hydroxyl group and at least an epoxy group based on total weight of the mixture. Furthermore, the resin composition mentioned in the above embodiments includes (1) 1 to 99.99 wt % mixture of epoxy and siloxane copolymer; (2) 0.01 to 5 wt % catalyst; (3) 0 to 40 wt % curing agent; (4) 0-5 wt % curing accelerator; (5) 0 to 10 wt % initiator;

(6) 0 to 30 wt % inorganic powders; and
(7) 0 to 10 wt processing additives.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A resin composition for optical lenses and optical packaging, comprising 1 to 99.99 wt % mixture (A) of epoxy, siloxane and epoxy-siloxane copolymers, 0.01 to 5 wt % catalyst (B) and 0 to 40 wt % curing agent (C), based on the total weight of the resin composition; wherein the mixture of epoxy and siloxane copolymer comprising.
(1) 1 to 85 wt % epoxy and siloxane oligomers, based on total weight of the mixture;
(2) 1 to 90 wt % siloxane containing at least one alkoxy group, based on total weight of the mixture;
(3) 1 to 80 wt % epoxy resin having a benzene ring with at least one epoxy up or a hydrogenated benzene ring, or aliphatic epoxy resin, based on total weight of the mixture; and
(4) 1 to 70 wt % epoxy resin containing at least one hydroxyl group and at least an epoxy group, based on total weight of the mixture.

2. The resin composition of claim 1, characterized in that the resin composition further comprising:
(1) curing accelerator, based on 0 to 5 wt % of total weight of the resin composition;
(2) initiator, based on 0 to 10 wt % of total weight of the resin composition;
(3) inorganic powders, based on 0 to 30 wt % of total weight of the resin composition; and
(4) processing additives, based on 0 to 10 wt % of total weight of the resin composition.

3. The resin composition of claim 1, characterized in that the mixture (A) of epoxy, siloxane and epoxy-siloxane copolymers is obtained by catalytic reaction of the siloxane containing at least one alkoxy group, epoxy resin having a benzene ring with at least one epoxy group or a hydrogenated benzene ring, or aliphatic epoxy resin, with the epoxy resin containing at least one hydroxyl group and at least an epoxy group, and has molecular weight in the range of 500 to 1,000,000, preferably 1,000 to 100,000.

4. The resin composition of claim 1, characterized in that the siloxane containing at least one alkoxy group has the following formula (1): 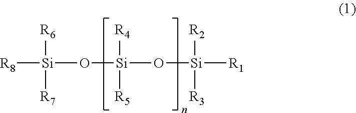
wherein n is an integer in the range of 0<n<100, R₁, R₂, R₃=phenyl group, or alkyl group of 1-6 carbon atoms or alkoxy group of 1 to 4 carbon atoms or alkyl group containing epoxy group or acrylate group, where R₁, R₂, R₃ are the same or different; R₄ is alkoxy group of 1 to 4 carbon atoms, or alkyl group containing epoxy group or acrylate group; R₅ is alkyl group of 1-6 carbon atoms, or phenyl group; R₆, R₇, R₈=one of phenyl group, alkyl group of 1-6 carbon atoms, alkoxy group of 1 to 4 carbon atoms, alkyl group containing epoxy group or acrylate group, where R₆, R₇, R₈ are the same or different;
when n>1, R₅ has, in molar ratio range, 0 to 100% alkyl group and 0 to 100% phenyl group, in a mixed formulation or single formulation of either alkyl group or phenyl group; when R₅ has both of alkyl group and phenyl group, it has the following formula (2): 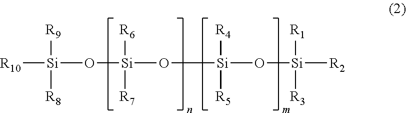
where:
n and in are integers in the range of 0<n<50 and 0<m<50; R₁, R₂, R₃=one of phenyl group, alkyl group of 1-6 carbon atoms, 1 to 4 carbon alkoxy, or alkyl group containing epoxy group or acrylate group, where R₁, R₂, R₃ are the same or different; R₄ is alkoxy group of 1 to 4 carbon atoms, or alkyl group containing epoxy group or acrylate group; R₅ is alkyl group of 1-6 carbon atoms; R₆ is any one of alkoxy group of 1 to 4 carbon atoms, alkyl group containing epoxy group or acrylate group, or branched methyl siloxane, phenyl siloxane or epoxy siloxane; R₇ is phenyl group; R₈, R₉, R₁₀=one of phenyl group, alkyl group of 1-6 carbon atoms, alkoxy group of 1 to 4 carbon atoms, or alkyl group containing epoxy group or acrylate group, where R₈, R₉, R₁₀ are the same or different.

5. The resin composition of claim 1, characterized in that the epoxy resin having a benzene ring with at least one epoxy group or a hydrogenated benzene ring, or aliphatic epoxy resin is an epoxy resin containing at least a single functional group with 100-2000 equivalents of epoxy, and is one or more selected from the up consisting of bisphenol-A epoxy resin, bisphenol-F epoxy resin, hydrogenated bisphenol-A epoxy resin, hydrogenated bisphenol-F epoxy resin, butadiene epoxy resin, o-cresol Novolac formaldehyde epoxy resin, cresol Novolac formaldehyde epoxy resin, cresol Novolac dibenzez formaldehyde epoxy resin, cresol Novolac xylene formaldehyde epoxy resin, cresol Novolac diphenyl formaldehyde epoxy resin, cresol Novolac dicyclopentadiene formaldehyde epoxy resin, cresol Novolac benzaldehyde epoxy resin, cresol Novolac propylidene diphenol formaldehyde epoxy resin, and cresol Novolac resorcinol epoxy resin.

6. The resin composition of claim 1, characterized in that the epoxy resin containing at least one hydroxyl group and at least an epoxy group has the following formula (3): 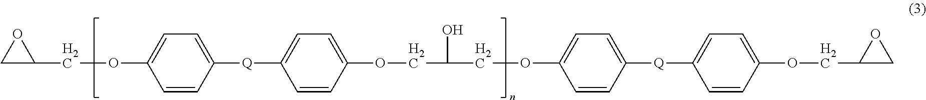
where
n is an integer in the range of 0<n<6; Q is 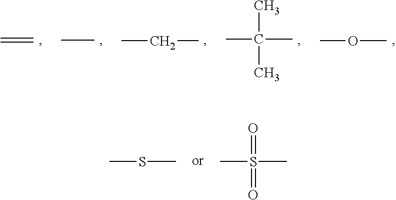
with the epoxy equivalents of 100-2000, and selected from the group consisting of bisphenol-A epoxy resin, bisphenol-F epoxy resin, hydrogenated bisphenol-A epoxy resin, hydrogenated bisphenol-F epoxy resin, or hydroxyl group-containing epoxy which is replaced with a hydroxyl group-containing fluorine resin.

7. The resin composition of claim 1, characterized in that the curing agent is an anhydride curing agent, and is selected from the group consisting of styrene-maleic anhydride, phthalic anhydride, tetrahydrophthalic anhydride, hexahydrophthalic anhydride, methyl tetrahydrophthalic anhydride, methyl hexahydrophthalic anhydride, methyl nadic anhydride, dodecenyl succinic anhydride, green bacteria anhydride, pyromellitic anhydride, benzophenonetetracarboxylic dianhydride, ethylene glycol di[trimellitic anhydride], methyl cyclohexenyl tetracarboxylic dianhydride, trimellitic anhydride or poly azelaic anhydride.

8. The resin composition of claim 2, characterized in that the curing agent accelerator is selected from the group consisting of tertiary amine and the salts thereof, quaternary amine salt compound, 2,4,6-tris(dimethyl amino methyl)phenol, benzyl dimethylamine, imidazole, tripentyl phenolate ammonium, mono- or poly-phenolic compounds, complex of boron trifluoride and organic compounds, or triphenyl phosphate or phosphite.

9. The resin composition of claim 2, characterized in that the initiator is one or more selected from the group consisting of diazonium salt, sulfonium salt and iodonium salt mixture.

10. The resin composition of claim 1, characterized in that the catalyst is one or more selected from the group consisting of titanium, tin, aluminum, zinc, boron organic metals and phosphate catalyst.

11. The resin composition of claim 2, characterized in that the inorganic powders are one or more selected from the group consisting of spherical or irregular silicon dioxide, niobium oxide, tantalum oxide, zirconia, alumina, titanium dioxide, aluminum hydroxide, magnesium hydroxide, calcium carbonate or smoked silica, with the average size of 0.1 to 20 microns, wherein a coupling agent is used to modify the interface affinity between the inorganic powders and the resin, and the ratio of the inorganic powder in the resin composition is 0˜30 wt %.

12. The resin composition of claim 2, characterized in that the inorganic powders are one or more selected from the group consisting of spherical or irregular silica, niobium oxide, tantalum oxide, zirconium oxide, alumina, titanium dioxide, aluminum hydroxide, magnesium hydroxide, calcium carbonate or smoked silica, with average particle size of 1-100 nanometers, and the ratio of nano inorganic powder in the resin composition is 0˜30 wt %.

13. The resin composition of claim 2, characterized in that the processing additives is one or more selected front the group consisting of absorbers, tillers, coupling agents, plasticizers, dispersants, antioxidants, heat stabilizers and light stabilizers, flame retardants, pigments or dyes.

14. The resin composition of claim 1, characterized in that 10 to 60 wt % epoxy and siloxane oligomers based on the total weight of the copolymer mixture is contained.
